(19) United States
(12) Patent Application Publication
(10) Pub. No.: US 2026/0127616 A1
(43) Pub. Date: May 7, 2026

(54) Neuro-Symbolic Intelligence Configured for Transaction Dispute Resolution

(71) Applicant: Bank of America Corporation, Charlotte, NC (US)

(72) Inventors: Jemlin Lucas, Coppell, TX (US); Suryanarayana Adivi, Hyderababd (IN); Pushkar Taneja, Hyderabad (IN)

(21) Appl. No.: 18/936,135

(22) Filed: Nov. 4, 2024

(51) Int. Cl. G06Q 20/40

(52) U.S. Cl. CPC G06Q 20/407; G06Q 20/405

(57) ABSTRACT

Transactions may be disputed. Accordingly, streamlining and anticipating possible disputes with transactions may help achieve improved transaction processing efficiency and enhance customer satisfaction. In some arrangements, a transaction processing and dispute resolution system may determine a dispute propensity score for a transaction in order to anticipate and possibly avoid possible disputes for a transaction. This determination may be performed by configuring and applying transaction parameters to a neuro-symbolic artificial intelligence (AI) model. Additionally, the transaction processing and dispute resolution system may also automatically identify resolutions to transaction disputes when they arise using smart contracts. In such a system, the transaction-in-dispute may be analyzed using a neuro-symbolic AI model to identify possible updates to the smart contract rules. This allows the model to further adapt and learn based on new contexts and information.

### BACKGROUND

Aspects described herein relate to electrical computers, systems, and devices for processing transactions and possible transaction disputes in an efficient, secure, and reliable manner.

Online and computer transactions have rapidly evolved, and real-time transactions have become the norm. Although such transactions provide convenience and efficiency, disputes arising from such transactions are increasing and oftentimes pose significant challenges. Existing dispute resolution processes are largely manual and can be slow and labor-intensive. Accordingly, such processes may lead to delays, additional costs, and negative impacts on the customer experience and satisfaction. In one example, users have the capability to make payments through a mobile app to transfer funds to another user's account. However, in some cases, a transaction may be disputed by the sending bank due to various reasons, including the sender's account not having less than the amount of needed funds. Some current dispute resolution processes would require a customer to visit a physical bank facility or raise the complaint in a customer center, provide identification documents, and wait for the bank to investigate and resolve the issue. This process can take several days or even weeks, adding to computing processing load, consuming personnel resources, and causing frustration and inconvenience to the customer or user.

### BRIEF SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects described herein relate to systems, methods, apparatuses and processes that combine artificial intelligence (AI) models, blockchain technology, adaptive smart contracts, and AI-enhanced oracles to streamline claims settlement and dispute resolution. In some arrangements, the systems, methods, apparatuses and processes implement a neuro-symbolic AI model to facilitate the settlement and resolution. The systems, methods, apparatuses and processes are configured to analyze complex rules and conditions, dynamically adjust security settings, and make informed decisions in real-time. In some examples, the neuro-symbolic AI model may provide reasoning capabilities to interpret complex rules and conditions, enabling the system to understand the context of each transaction and make informed decisions that consider the specific circumstances of each case.

According to one or more aspects, systems, methods, apparatuses and processes may learn from transaction and/or dispute resolution data and adapt its behavior to improve dispute resolution, ensuring that the system becomes more effective over time.

According to one or more aspects, the systems, methods, apparatuses and processes include smart contract orchestration features which are configured to provide reasoning capabilities to interpret complex rules and conditions, enabling dynamic adjustment of smart contract rules and behavior based on AI predictions and analysis.

According to one or more further aspects, systems, methods, apparatuses and processes provide dynamic rule updates, such as rules applied in a smart contract. Such a feature may analyze data and context to suggest updates or modifications to the rules governing smart contracts, ensuring that the system adapts to changing circumstances and remains up-to-date.

According to one or more aspects, the systems, methods, apparatuses and processes described herein provide fraud detection and prevention features. For example, the system's fraud detection and prevention capabilities may identify high-risk transactions and dynamically adjust security settings to prevent fraud, ensuring the security and integrity of transactions.

According to further aspects, the systems, methods, apparatuses and processes are configured to provide more detailed and clearer explanations for dispute resolution decisions and improves transparency throughout the transaction completion and dispute resolution process, enabling stakeholders to understand the reasoning behind the system's decisions.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for a transaction and dispute processing system and service in accordance with one or more aspects described herein;

FIGS. 2A and 2B illustrate an example process flow for transaction processing and dispute resolution accordance with one or more aspects described herein;

FIG. 3 is a flowchart illustrating an example method for determining a dispute propensity score according to one or more aspects described herein;

FIG. 4 is a flowchart illustrating an example method for resolving a transaction dispute and dynamically updating rules for transaction dispute resolution according to one or more aspects described herein;

FIG. 5 is a flowchart illustrating an example method for transaction and dispute security and compliance monitoring according to one or more aspects described herein; and

FIG. 6 depicts an illustrative architecture and operating environment for a transaction and dispute resolution processing system according to one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As discussed herein, transactions may be subject to disputes. For example, disputes may arise if a transaction (e.g., financial transaction) is unauthorized, if a sending account has less than an amount of needed funds, if a recipient account was incorrectly specified, and the like. Manual resolution of these disputes may be time and resource consuming and cause dissatisfaction among customers, thereby negatively impacting the customer experience. Additionally, disputes may lead to delays in commercial transactions, which may negatively impact business operations.

Accordingly, aspects described herein provide systems and methods for improving the efficiency and effectiveness in processing transactions and processing and resolving transaction disputes. In one or more arrangements, the systems and methods may include determining a likelihood of dispute to help minimize the chances of a dispute arising in the first instance. For example, determining a dispute likelihood score may help to prepare systems, personnel and/or resources for the possible need to process and resolve an expected dispute. Determining a dispute propensity score may include analyzing the transaction data, including a device through which the transaction was made, a transaction type, a customer identification, a geographic location from which the transaction was made, a transaction amount, and the like and/or combinations thereof. The transaction data may be analyzed with a neuro-symbolic artificial intelligence (AI) model to determine the propensity score. For example, the AI model may determine patterns or relationships between the transaction data and historical transaction and/or dispute information. In some examples, the propensity score may further be adjusted based on a confidence score. The confidence score may be determined based on an amount of data used to train the AI model. Further, according to some aspects, the dispute propensity score may be used to determine whether to impose or otherwise require security protocols, such as multi-factor authentication or adding the transaction to a watchlist, in order to complete the transaction.

According to one or more further aspects, dispute resolution may include the use of smart contracts (e.g., in a blockchain network) that have predefined rules for how a transaction dispute is to be managed and resolved. In one example, if a dispute is raised for a particular transaction, a smart contract may be invoked that locks a particular account involved in the transaction for a specified amount of time (e.g., blocks the account from transactions). The smart contract rules used for dispute resolution may be analyzed and updated using a neuro-symbolic AI model. For example, rule updates may be triggered when a transaction, for which a dispute is received, is determined to be a complex transaction. New or updated rules may then be generated using the neuro-symbolic AI model, and corresponding smart contracts updated or created to reflect those changes. Once the smart contract rules have been updated, the transaction dispute may be analyzed and a resolution identified using the updated smart contracts.

These and various other arrangements will be discussed more fully below.

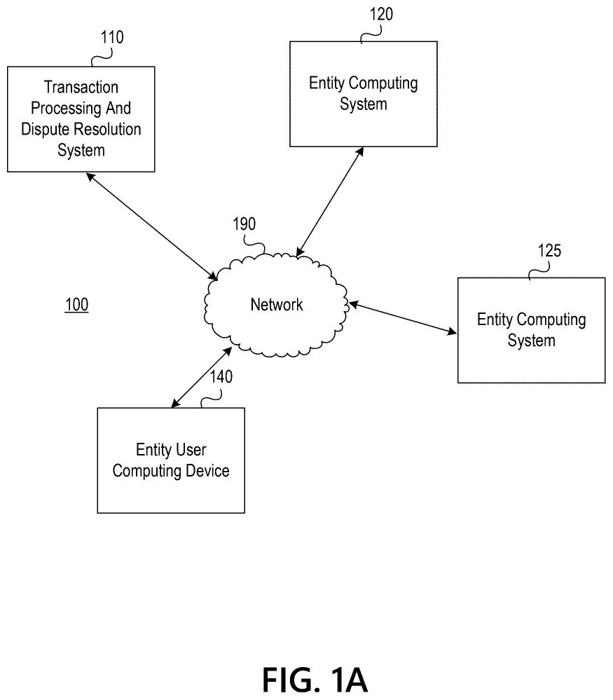

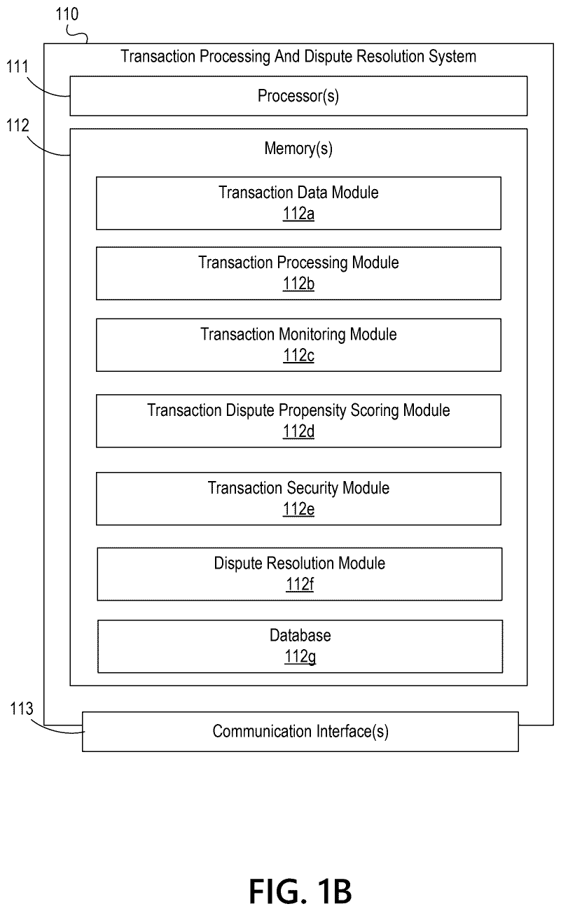

FIGS. 1A-1B depict an illustrative computing environment for implementing a transaction processing and dispute resolution system and process in accordance with one or more aspects described herein. Referring to FIG. 1A, computing environment 100 may include one or more computing devices and/or other computing systems. For example, computing environment 100 may include transaction processing and dispute resolution system 110, entity computing system 120, entity computing system 125 and entity user computing device 140. Although two entity computing systems 120, 125 and one entity user computing device 140 are shown, any number of systems or devices may be used without departing from the invention.

Transaction processing and dispute resolution system 110 may be or include one or more computing devices (e.g., servers, personal computers (PCs), routers, mobile devices, server blades, or the like) and/or one or more computing components (e.g., memory, processor, and the like) and may be configured to receive or otherwise receive and process transactions, monitor for disputes, and resolve those disputes. Additionally, in some arrangements, the transaction processing and dispute resolution system 110 may generate alerts, recommendations, information, reports, notifications and commands relating to the transactions, rule dates and smart contracts, and disputes. Such alerts, commands, and the like may be provided to another device (e.g., entity user computing device 140 and/or entity computing systems 120, 125). The other device may include one or more of a device from which a transaction or dispute originated or was otherwise received, a user device configured to monitor transaction or dispute processing, a system for logging and monitoring transactions and dispute processing, and the like and/or combinations thereof. In some examples, the alerts, reports, and/or notifications may be transmitted to the entity user computing device 140 and/or entity computing systems 120, 125 to cause those devices to execute one or more commands. The other device may then be controlled to execute the command (e.g., display an alert or terminate or hold a transaction, execute security script to log transaction information, execute security code to limit functionality, command to initiate a fund transfer, command to initiate a voice call, instructions for multi-factor authentication, etc.) in response to receiving the communication from the transaction processing and dispute resolution system 110. In one example, if a transaction is determined to have a threshold dispute propensity score, the transaction processing and dispute resolution system 110 may send a command to entity user computing device 140 (e.g., a device of a financial organization associated with the requested transaction or an entity requesting the transaction) to monitor that transaction as part of a transaction watch queue.

In one arrangement, transaction processing and dispute resolution system 110 may be configured to receive a transaction request, extract transaction parameters, evaluate a likelihood that the transaction will be subject to a dispute, and determine whether the transaction is to be monitored. For example, the transaction processing and dispute resolution system 110 may receive a transaction request and determine various parameters from the request information. These parameters may include a transaction type, geographic location where the transaction was made or initiated, a transaction amount, entities involved in the transaction (e.g., a payee and a payor), financial institution associated with the transaction, account identifiers, a product or service associated with the transaction and the like and/or combinations thereof. The transaction processing and dispute resolution system 110 may input one or more of these transaction parameters into a neuro-symbolic AI model to determine a dispute propensity score. This dispute propensity score may indicate a likelihood that the transaction will be the subject of a dispute. In some examples, the AI model may include both a neural engine as well as symbolic logic model. This may allow for both logical rules to be defined and applied as well as machine learning to identify relationships and probabilities based on training data (e.g., historical transaction and dispute data).

According to some aspects, the transaction processing and dispute resolution 110 may further be configured to determine a confidence score associated with a propensity score. For example, the transaction processing and dispute resolution system 110 may determine an initial propensity score using an AI model, and subsequently determine a confidence score based on an amount of data used to train the AI model. Other manners for determining a confidence level or score may be used. In some examples, that confidence score may then be applied to the initial propensity score to generate a final dispute propensity score.

The transaction processing and dispute resolution system 110 may use the dispute propensity score to determine whether to take one or more further actions regarding the transaction. For example, if the dispute propensity score is of a threshold level or greater, the transaction processing and dispute resolution system 110 may add the transaction to a watch queue for further or closer monitoring. Monitoring may include executing a monitoring application to log and detect various status updates during the processing of the transaction. For example, the monitoring application or module may generate an alert for a watched transaction if a funds request has been pending for a certain amount of time. In another example, the monitoring application or module may generate an alert if an intervening modification to the transaction is requested. Adding a transaction to a watch queue for closer monitoring may also include monitoring a transaction at a greater frequency or for more information than a transaction that has a dispute propensity score lower than the threshold.

Additionally, the transaction processing and dispute resolution system 110 may be configured to process transaction disputes, including identifying a resolution and updating rules for determining an appropriate resolution. For example, transaction processing and dispute resolution system 110 may configure one or more smart contracts in a blockchain network for processing transactions and/or transaction disputes. Those smart contracts may define or specify resolutions given a set of transaction parameters. In such arrangements, the transaction processing and dispute resolution system 110 may be configured to detect a dispute associated with a transaction, and evaluate the dispute and transaction parameters. For example, the transaction processing and dispute resolution system 110 may extract transaction parameters associated with the transaction in dispute, and subsequently determine whether the transaction is a complex transaction. A complex transaction may refer to a transaction that includes new or previously undetected patterns in transaction behavior of a particular entity (e.g., customer, business). New patterns or behaviors may be detected using a neuro-symbolic AI model as discussed in further detail below. If the transaction is determined to be a complex transaction, the transaction processing and dispute resolution system 110 may invoke a rules update module or process in which one or more smart contracts (or rules thereof) may be modified and/or updated. The update process may also invoke a neuro-symbolic AI model to determine different or new resolutions for various transaction and/or dispute parameters. The smart contracts may then be updated prior to the dispute being analyzed for a resolution using those smart contracts.

The transaction processing and dispute resolution system 110 may further be configured to provide fraud detection and prevention based on the rule updates. Accordingly, when a rule is updated, new and/or different security protocols may be required during transaction processing based on those updates. Additionally, transaction processing and dispute resolution system 110 may include monitoring and governance functionality to insure transparency and security of any transaction processing, dispute processing and/or modifications and updates to the transaction or dispute processing rules (e.g., smart contract rules).

Entity computing system 120 and/or entity computing system 125 may be or include one or more computing devices (e.g., servers, routers, gateways, network nodes, personal computers (PCs), mobile devices, server blades, or the like) and/or one or more computing components (e.g., memory, processor, and the like) and may be configured to host or execute one or more organization applications or systems. For instance, entity computing system 120 and/or entity computing system 125 may host or execute internal or user-facing applications or systems that may be accessed by one or more users in-person or remotely, such as via a network, such as a private network, public network, or the like. Entity computing system 120 and 125 may be terminals operated by a customer for providing products or services, general purpose computing devices providing function-specific applications, and/or function-specific devices such as ATMs, maintenance devices, electronic vaults, cash registers, points of sale system, and the like and/or combinations thereof. The entity computing system 120 and/or 125 may further be used to input or request performance of one or more tasks or processes by a customer or user external to an organization.

Entity user computing device 140 may be or include a computing device such as a desktop computer, laptop computer, tablet, smartphone, wearable device, and the like, that is associated with a user (e.g., an employee) of the organization. Entity user computing device 140 may communicate with transaction processing and dispute resolution system 110 and/or entity computing systems 120, 125 to receive notifications and other information associated with requested transactions or disputes. In some arrangements, the entity user computing device 140 may be used to monitor transactions or disputes. In other examples, the entity user computing device 140 may be used to confirm or approve actions requested through entity computing system 120 and/or 125. For example, if a request is made to authorize a large transaction amount, the approval or confirmation may be entered through entity user computing device 140.

As mentioned above, computing environment 100 also may include one or more networks, which may interconnect one or more of transaction processing and dispute resolution system 110, entity computing system 120, entity computing system 125, and/or entity user computing device 140. For example, computing environment 100 may include network 190. Network 190 may include one or more sub-networks (e.g., Local Area Networks (LANs), Wide Area Networks (WANs), or the like). Network 190 may be associated with a particular organization (e.g., a corporation, financial institution, educational institution, governmental institution, or the like) and may be a private network interconnecting one or more computing devices associated with the organization. For example, transaction processing and dispute resolution system 110, entity computing system 120, entity computing system 125, and/or entity user computing device 140 may be associated with an organization (e.g., a financial institution), and network 190 may be associated with and/or operated by the organization, and may include one or more networks (e.g., LANs, WANs, virtual private networks (VPNs), or the like) that interconnect transaction processing and dispute resolution system 110, entity computing system 120, entity computing system 125, and/or entity user computing device 140 and one or more other computing devices and/or computer systems that are used by, operated by, and/or otherwise associated with the organization. Additionally or alternatively, network 190 may be a public network, such as the internet, that may connect the systems and devices described. In yet other examples, network 190 may include a combination of public and private networks.

Referring to FIG. 1B, transaction processing and dispute resolution system 110 may include one or more processors 111, memory 112, and communication interface 113. A data bus may interconnect processor(s) 111, memory 112, and communication interface 113. Communication interface 113 may be a network interface configured to support communication between transaction processing and dispute resolution system 110 and one or more networks (e.g., network 190, or the like). Memory 112 may include one or more program modules having instructions that when executed by processor(s) 111 cause transaction processing and dispute resolution system 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of transaction processing and dispute resolution system 110 and/or by different computing devices that may form and/or otherwise make up transaction processing and dispute resolution system 110.

For example, memory 112 may have, store and/or include transaction data module 112a. Transaction data module 112a may be configured to collect and/or store information about requested transactions including a requester, an identifier, a status, transaction amount, transaction type, financial institutions, product or service associated with the transaction, geographic location of the payor and/or payee, device(s) used to make the transaction, application or software used to make the transaction, and the like. The transaction information may be used to not only process the transaction, but also to evaluate dispute propensity, implement fraud prevention measures, and/or to identify a resolution for possible disputes. The transaction data module 112a may also collect and/or store security information such as security tokens, private/public keys, other encryption information, and the like.

Transaction processing and dispute resolution system 110 may further have, store and/or include transaction processing module 112b. Transaction processing module 112b may be configured to manage and/or facilitate the overall processing of a transaction, and may be configured to interface with one or more of the other modules 112a, 112c-g in performing transaction processing. Transaction processing may include issuing fund transfer requests or instructions for sending payment to another financial institution or account, or confirming receipt of an expected payment. Transaction processing may also include invoking a dispute propensity scoring module 112c to determine a dispute propensity of the transaction, which may be used to decide whether a transaction should be placed on a monitoring or watch queue. Transaction processing may further include sending reports, notifications, confirmations, and the like corresponding to status updates.

Additionally, transaction processing and dispute resolution system 110 may have, store and/or include a transaction monitoring module 112c. Transaction monitoring module 112c may be configured to monitor or watch for status updates for a particular transaction. In one example, the transaction processing module 112b may instruct the transaction monitoring module 112c to monitor for particular status updates for a transaction and/or at a particular frequency if the transaction receives a threshold dispute propensity score. In other examples, monitoring module 112c may monitor a transaction if one or more security risks are identified. In a particular example, if a transaction amount is of a threshold level or greater, the transaction monitoring module 112c may more strictly monitor that transaction (e.g., more frequently checking on the status of a transaction, record more types of transaction status parameters). Transaction monitoring module 112c may also be configured to monitor different transactions differently, e.g., at different intervals, with different frequencies, for different transaction parameters or status information, and the like.

Transaction processing and dispute resolution system 110 may further have, store and/or include a transaction dispute propensity scoring module 112d. Transaction dispute propensity scoring module 112d may be configured to determine a likelihood that a transaction will trigger or otherwise receive a dispute. Transaction dispute propensity scoring module 112d may include one or more neural AI engines and/or symbolic AI models that may be used to determine dispute propensity. In one or more examples, the transaction dispute propensity scoring module 112d may further be configured to determine a confidence score for a determined propensity score. Still further, the propensity scoring module 112d may be configured to train and update the AI models using collected transaction and dispute data.

Transaction processing and dispute resolution system 110 may have, store and/or include a transaction security module 112e. Transaction security module 112e may be configured to implement or enforce security protocols associated with a transaction. For example, transaction security module 112e may be configured to enforce (e.g., request, obtain) multi-factor authentication for various transactions. In one arrangement, transaction security module 112e may enforce various security protocols based on a dispute propensity score being at or greater than a threshold level. In other examples, one or more security protocols may be enforced by the transaction security module 112e based on various transaction parameters and predefined rules outside of dispute propensity.

According to some aspects, the transaction processing and dispute resolution system 110 may also include a dispute resolution module 112f. Dispute resolution module 112f may be configured to receive or detect transaction disputes and to identify a resolution for those disputes. In one or more arrangements, the dispute resolution module 112f may include or more submodules or components, including a smart contract orchestration module, a dynamic rule update module, a complex decision-making module, fraud detection and prevention module, secure and transparent governance module, contextual understanding module and a learning and adaptation module. For example, dispute resolution module 112f may be configured to determine resolutions using smart contracts in a blockchain network. In such instances, dispute resolution module 112f may use the smart contract orchestration module to oversee or manage the dispute resolution determination process, including invoking the appropriate smart contracts and returning a selected or determined resolution. In some cases, the dispute resolution module 112f may evaluate whether a transaction associated with the dispute is a complex transaction using the complex decision-making module. If so, the dispute resolution module 112f may invoke the dynamic rule update module to evaluate whether one or more rules (or smart contracts) need to be modified or otherwise updated and the content of such updates. In one or more arrangements, the complex decision-making module and the dynamic rule update module may each configure and use a neuro-symbolic AI module in making their respective determinations.

Further, the fraud detection and prevention module may be configured to detect whether security protocols need to be updated based on whether a transaction is high-risk. The security protocols and triggers may be dynamically adjusted so that transaction processing is further secured in real-time. As part of the security of transaction processing and dispute resolution, dispute resolution module 112f may further include a governance module that is configured to monitor, log and provide oversight for the processing of disputes and transactions and for the modification or updating of rules. Further, the dispute resolution module 112f may include a contextual understanding module that is configured to learn context from transactions and disputes and further build a context information database using which the system 110 may evaluate transactions and disputes.

Transaction processing and dispute resolution 110 may further have, store and/or include database 112g. Database 112g may store further data, beyond what is stored in or by transaction data module 112a. For example, database 112g may store and/or other data that enables performance of aspects described herein by the transaction processing and dispute resolution system 110.

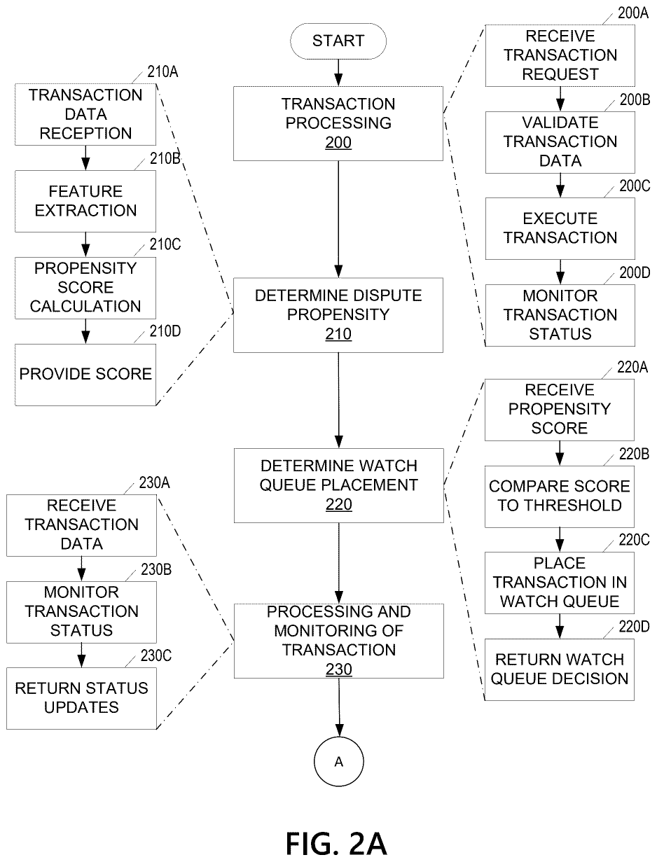

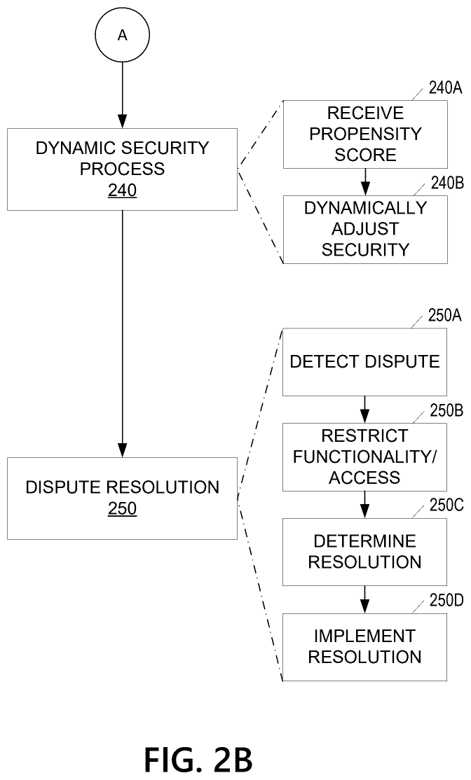

FIGS. 2A-2B illustrate an example process flow for processing a transaction and possible transaction dispute. This flow includes processing a requested transaction as well as detection of a dispute involving the transaction and a process for resolving or settling the dispute. In FIG. 2A, for example, transaction processing is represented by step 200, which may include steps 200A, 200B, 200C, and 200D. In one or more arrangements, in step 200A, transaction processing may include receiving a transaction request. The transaction request may be received by a transaction processing and dispute resolution system (e.g., system 110 of FIG. 1B) through a network or locally from a variety of sources. Those sources may include customers of an organization or entity (e.g., a financial customer, a customer of an Internet service provider (ISP)), and the requests may be received through mobile devices, customer kiosks, user terminals, other computing devices and systems, and the like.

In step 200B, the system may validate the transaction data. Validation may include determining whether the data entered matches data on record with the system or organization. For example, the system may confirm that a user's name and account number specified in the transaction request matches with the system's data records. In another example, validation may include confirming that a routing number and financial institution specified in the transaction request matches a database of routing numbers and corresponding financial institution names. Validation may further include confirming that a transaction type, transaction amount, transaction destination and the like are allowable for the user, account type, etc. Validation may also include confirming encryption and decryption keys match what is stored in the database or on record for the customer, e.g., if the transaction data is encrypted.

In step 200C, the system may execute the transaction upon confirming that the transaction data has been validated. Execution may include transmitting authorizations to, sending funds to, and/or requesting funds from another account, organization, entity, and/or system. For example, if a customer is making a purchase, and therefore, transmitting funds electronically, the system may initiate a funds transfer to the destination account and financial institution. In another example, if a customer is requesting money from another entity, the system may electronically initiate a funds transfer request from an account and/or financial institution of the other entity.

In step 200D, the system may, after executing the transaction, monitor the status of the transaction processing and update one or more systems, organizations, users, devices and the like of that status. For example, the system may periodically or based on some other schedule, check to see if a transaction has completed. Transaction completion may include receipt of funds requested, receiving acknowledgment that transmitted funds have been received by a destination financial institution system and/or account or entity, and the like. Status may be transmitted to a customer, to an employee or user of the system's organization, to a monitoring system or service, and the like and/or combinations thereof.

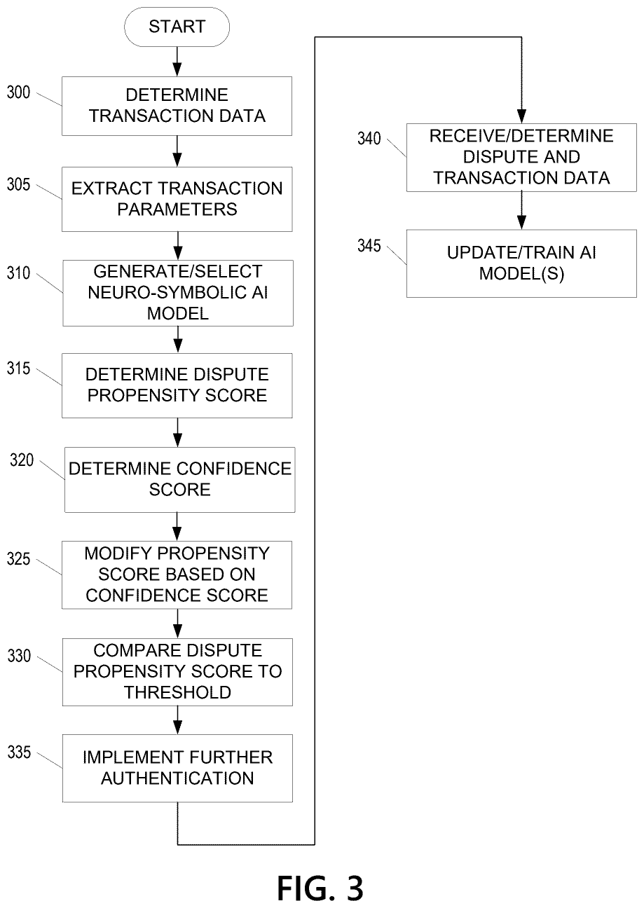

Step 210 includes a process for determining a dispute propensity for the requested transaction, and may be performed in parallel with, after or before the transaction execution of step 200. For example, after receiving the transaction request and/or validating the transaction data in steps 200A and 200B, respectively, the system may further determine a likelihood that a dispute will arise from the requested transaction. A dispute may refer to various issues such as a request or notification that the transaction was not authorized, was not requested, was not completed properly, could not be processed, or the like and/or combinations thereof. The dispute may originate from any of the parties involved with the transaction, including a customer, a recipient of funds, a fund source (e.g., a payor), a financial institution, and the like and/or combinations thereof. Step 210 may include multiple processes such as transaction data reception in step 210A, feature extraction in step 210B, propensity score calculation in step 210C and notification or transmission of the propensity score in step 210D. The propensity score analysis and calculation process is described in further detail with respect to FIG. 3 below.

Once a dispute propensity score is determined from step 210, the system may then determine whether the transaction should be placed in a watch queue in step 220. For example, in step 220A, the system may receive the propensity score from step 210. Subsequently, the system may compare this propensity score to a threshold score or value in step 220B. If the propensity score is equal to or greater than the threshold, the system may place the transaction in a watch queue for more detailed or otherwise closer monitoring in step 220C. For example, the watch queue may be configured to indicate to an organization user or employee to monitor (or more closely monitor) updates to the transaction status and/or to conduct further analysis or research into the requested transaction. In step 220D, a decision as to whether the transaction is added or not added to a watch queue may be provided to one or more other processes or systems.

Step 230 may include the processing and monitoring of transaction status. For example, after a transaction has been executed and a dispute propensity score determined, the system may perform transaction monitoring to keep the status of the transaction updated. In step 230A, for example, transaction data may be received to identify the transaction and information to be monitored. In step 230B, the status of that transaction may then be monitored. For example, the system may request a current status of the transaction at various times. That request may also indicate transaction parameters that are to be returned (i.e., monitored). Finally, in step 230C, when a change occurs with the status of the requested transaction, an update may be provided to one or more systems, entities, users, and the like.

In some arrangements, the transaction processing and monitoring step may be performed differently depending on a dispute propensity score. For example, a transaction status may be more frequently queried and updated if the transaction is on the watch queue (i.e., that the dispute propensity score is greater than the threshold). In other examples, more granular types of transaction status updates may be used if the transaction is added to the watch queue. Additionally or alternatively, different attributes of a transaction may be monitored depending on whether the transaction is added to the watch queue or not.

FIG. 2B is an example flowchart continuing the process flow of FIG. 2A. For example, in step 240 includes a dynamic security process that is configured to modify and/or update security settings to safeguard transactions. For example, security settings including transaction amount limits, multifactor authentication, geographic restrictions, allowable transaction entities, and the like may be defined and/or updated based on the transaction dispute propensity score. Accordingly, in step 240A, the system may first receive or determine the dispute propensity score from the process of step 210. Subsequently, the system may, in step 240B, dynamically adjust security settings or processes associated with the user, the account, the transaction, the financial institution, and the like and/or combinations thereof. In one or more examples, if the system determines that the dispute propensity score is above the threshold in process 210, or a different threshold, the system may request multifactor authentication for the transaction in a real-time and dynamic manner. The updated security settings, such as the request for multifactor authentication or manual approval or review, may be returned to one or more processes, modules, and/or systems for implementation and enforcement. For example, the multifactor authentication requirement setting may be returned to the transaction processing and monitoring process so that multifactor authentication may be requested from the customer or other user as the transaction is being executed and processed. This allows for the implementation of updated security settings on-the-fly (e.g., in real-time), instead of just enforcing the change for a subsequent or future transaction.

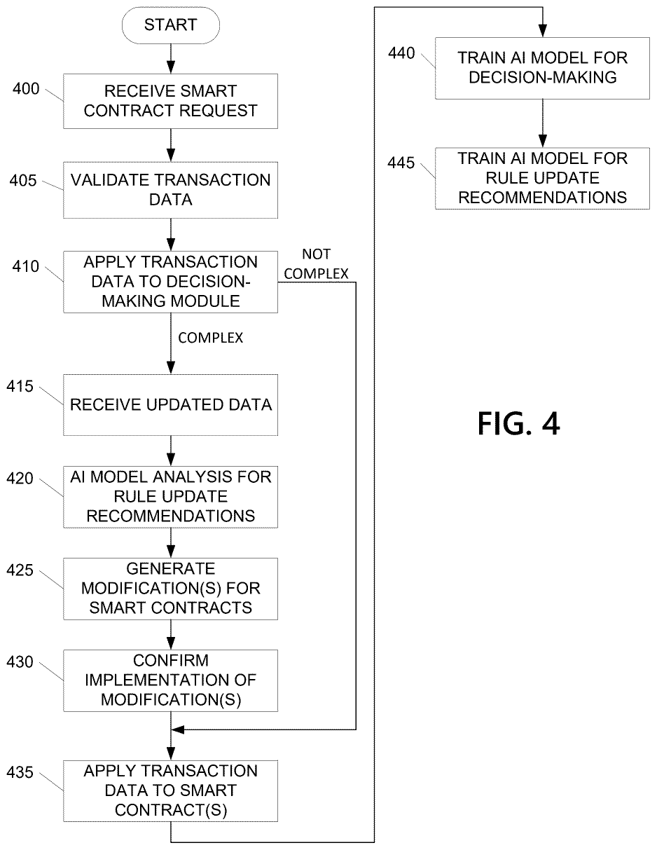

Step 250 includes a process for dispute analysis and resolution. For example, step 250 may include detecting that a dispute has been filed, submitted, entered, or otherwise received relating to a particular transaction in step 250A. In step 250B, the system may restrict the functionality and/or access to one or more accounts associated with the disputed transaction. For example, the restriction may be implemented and maintained while a resolution is determined. In step 250C, the system may determine a resolution to the dispute and subsequently implement the resolution in step 250D. The dispute analysis and resolution process is described in further detail with respect to FIG. 4 below.

FIG. 3 illustrates an example process for determining a dispute propensity score for a transaction according to one or more aspects described herein. In some arrangements, the process of FIG. 3 may be performed as part of step 210 in FIG. 2A. Referring to FIG. 3, in step 300, a dispute propensity score determination module of a computing system (e.g., transaction processing and dispute resolution system) may receive, determine or otherwise obtain transaction data. In step 305, the system may extract or otherwise determine transaction parameters or features from the received transaction data. In one or more examples, the transaction parameters or features to be determined may be predefined or preselected. In some arrangements, the types of parameters or features to be extracted may be defined based on and specific to a transaction type. Accordingly, prior to transaction parameter extraction or determination, the system may first determine a type of transaction in some arrangements. For example, if the transaction is a payment (e.g., sending money from one party to another for a product or service), the system may obtain transaction parameters including a sending (originating or payor) account number, a recipient (destination or payee) account number, a recipient financial institution routing number, transaction history of the sending account for a specified period of time (e.g., 30 days, 60 days, a month, 3 months, a year), transaction history of the recipient account for a specified period of time, a transaction amount, a type of product or service associated with the transaction, and the like and/or combinations thereof. In other examples, the parameters or features may be defined based on account type (savings, checking, brokerage, joint, etc.), customer type (e.g., business, individual), transaction amount (e.g., defined based on threshold amounts), and the like and/or combinations thereof.

In step 310, the system may generate or select a neuro-symbolic AI model for analyzing the transaction data based on one or more parameters of the transaction. For example, one AI model may be generated and/or selected for commercial transactions, while another (different) AI model may be generated and/or selected for peer-to-peer fund transfers. In another example, a different AI model may be generated and/or selected for brokerage accounts versus checking accounts. In some arrangements, the same neuro-symbolic AI model may be used for all or multiple types of transactions. Generating a neuro-symbolic AI model may include obtaining a transaction history associated with one or more transaction parameters, such as a customer, a geographic location, a transaction type, an account type, a financial institution, and the like. That information may then be used to build a machine learning model comprising a plurality of nodes and connections representing relationships, correlations, and decisions that may exist within the historical data. Additionally, one or more symbolic models comprising logical rules may also be generated based on that historical data. In some examples, the symbolic logic may be incorporated within the neural machine learning model.

In step 315, the system may input the transaction parameters or features into the selected and/or generated neuro-symbolic AI model and determine a transaction dispute propensity score. As discussed, in some examples, the neuro-symbolic AI model may include a combination of logical rules (e.g., if-then conditions) as well as neural nodes and connections representing relationships, correlations, and likelihoods between parameters (represented by the nodes) or other types of data. In one example, certain parameters may be analyzed using symbolic (e.g., logical) conditions, while other parameters of the transaction may be analyzed using neural machine learning models. Accordingly, a symbolic portion of an AI model may be used to determine a first initial (symbolic) propensity score based on a subset of one or more transaction parameters, while a neural engine portion of the AI model may be used to determine a second initial (neural engine) propensity score based on another subset of one or more transaction parameters. Those initial propensity scores may then be combined in a variety of ways to generate an initial dispute propensity score indicative of a likelihood that the transaction will be disputed. In some examples, one initial propensity score (e.g., the neural engine score) may be weighted more heavily than another initial propensity score to determine a combined initial propensity score. Alternatively or additionally, the weighting may be dictated by the transaction parameter. In some arrangements, initial symbolic and neural engine propensity scores may be generated for the same or an overlapping set of transaction parameters.

According to some aspects, symbolic logic may be incorporated into a neural engine such that relationships between nodes may be affected by the symbolic logic expressions. For example, symbolic logic incorporated into a neural node may dictate or otherwise modify the strength of a relationship or correlation between that node (e.g., a transaction parameter) and another node (e.g., another transaction parameter), e.g., depending on whether a logical condition is true or false. In one example, a neuro-symbolic model may include a first node representing a transaction amount and a second node representing a particular type of transaction dispute. The two nodes may be connected with the connection representing a likelihood that the transaction amount corresponds to (e.g., have a likelihood of being subject to) a particular type of transaction dispute. Symbolic logic within the first node representing the transaction amount may include a condition such as a threshold transaction amount. Depending on whether the transaction amount is less than or equal to or greater than the threshold, the correlation likelihood may be increased or decreased (e.g., increase or decrease the likelihood that the transaction amount corresponds to that transaction dispute type). Correlation or correspondence may generally indicate whether one parameter typically occurs with another parameter. Various other methods or manners of incorporating symbolic logic with neural engines may be used.

In step 320, the system may further determine a confidence score for the determined initial dispute propensity score. The system may determine a confidence score based on a variety of factors including an amount of data that was used to train the model, the number of rules defined in a symbolic logic model, and other factors that may indicate a robustness of the neuro-symbolic AI model. In some examples, the confidence score may also be affected by the transaction type, customer type, transaction amount, etc. That is, a confidence level may be lower if the transaction type is of one type versus another type, or if the customer is an individual versus a business. In other examples, a confidence score may be higher or lower if the transaction amount exceeds a certain threshold. The confidence score or a confidence score modifier may be determined prior to or in conjunction with step 315. Accordingly, the system may compare how much data of a first transaction type was used to train the AI model in comparison to an overall amount of data of all transaction types used to train the model. The system may then derive a confidence score based on a percentage of training data of the first transaction type, if the transaction is of that type. In another example, a confidence score may be predefined at a first level if the transaction amount is less than a threshold amount, and at a second level if the transaction amount is equal to or greater than the threshold amount. Multiple thresholds and more than two confidence score levels may be defined as needed or desired.

In step 325, the determined confidence score may be used as a modifier for the initial dispute propensity score to determine a final dispute propensity score. The initial dispute propensity score may be modified in a variety of ways including by multiplying the confidence score, adding the confidence score, or some other formula that includes the confidence score and initial dispute propensity score. In some examples, the confidence score might not be used to modify the initial dispute propensity score. Instead, the confidence score might simply be returned as a further parameter. In such an instance, the initial dispute propensity score may be the final dispute propensity score.

In step 330, the final dispute propensity score may, in one or more arrangements, be compared to a threshold. This threshold may be a predefined propensity level at which an organization may require further action, review and/or safeguards. In one example, if the final dispute propensity score is greater than a threshold, the system may issue a challenge or authentication request in step 335 to a user or entity involved in the transaction to further confirm the authenticity of the transaction request. This challenge may include multi-factor authentication protocols, encrypted communications, and the like and/or combinations thereof. In another example, the transaction may be added to a watch queue if the final propensity score is higher than a threshold level.

In step 340, the dispute propensity scoring module of the system may further receive or otherwise determine dispute data relating to one or more prior transactions, along with corresponding transaction information. The dispute data may include disputes submitted or filed and/or a resolution determined and applied. This information (dispute data and transaction information) may then be used to further train one or more of the dispute propensity determination neuro-symbolic AI models in step 345. Additionally, the amount of data used to further train the models may be recorded or quantified in order to assist in the determining of a confidence score as discussed for step 320.

FIG. 4 illustrates an example process for analyzing a dispute and applying machine learning to update or create one or more rules and smart contracts for transaction processing. For example, the system may use the rules and smart contracts to determine dispute resolutions. In step 400, the system may receive a smart contract request for dispute resolution. The request may include the transaction data for the disputed transaction. The transaction data may include a variety of information such as names or identifiers of the entities involved in the transaction, one or more accounts associated with the transaction, names or identifiers of corresponding financial institutions, a type of dispute (e.g., transferor account having less than an amount of needed funds, unauthorized activity, incorrect amount), a geographic location from which the transaction was made or requested, an originating device of the transaction, a transaction amount, and the like and/or combinations thereof. In step 405, the system may validate the transaction data to be fed into one or more smart contracts. Validation may include verifying that the data is in a correct format, parsing the data to align the formatting or structure to an expected input structure of a smart contract, confirming identifiers or account numbers are valid (e.g., exist or match the other transaction data provided) and the like. In one or more arrangements, after receiving a dispute, an account associated with the disputed transaction may be blocked from making transactions or otherwise frozen for a period of time (e.g., a predefined time period, until a resolution is identified).

In step 410, the system may then apply the transaction data to a decision-making module to determine whether the transaction is a complex transaction. A complex transaction in some examples may refer to a transaction that establishes a new (i.e., previously non-detected or unrecognized) pattern involving one or more transaction attributes. In one example, the decision-making module may receive the transaction data of the disputed transaction, and generate or otherwise identify patterns through an AI-enhanced oracle. The oracle may bridge the smart contracts (which exist as part of a blockchain) with outside data sources such as a source of the transaction data. Additionally, the decision-making module may apply the transaction data to a neuro-symbolic AI model to determine whether one or more new patterns exist. For example, the system may have previously identified patterns associated with a particular customer that includes one or more of making monthly deposits, using a particular mobile device, making transactions from a specific geographic location, and making transaction using a particular account. However, if the received transaction data establishes a new pattern that shows the particular customer also typically makes transactions from another geographic location, the system may determine that this transaction is of a complex type. The system may make this determination so that rules, code, and smart contracts may be updated to address this newly learned or identified information. Accordingly, the decision-making module may further return the determination of whether the transaction is complex or not to the system for further processing of the dispute. In some arrangements, the neuro-symbolic AI model may be specific to a transaction feature or feature type, such as a transaction type, customer type, transaction level/amount, geographic location and the like.

If the transaction is deemed to be not complex, the system may proceed to step 435 where a resolution for the dispute is determined, as discussed in further detail below. If, however, the transaction is determined to be complex, the system may further analyze the transaction data against existing rules to determine whether rule updates or changes are needed. For example, in step 415, the system may receive updated rule data, which may comprise the new transaction data and/or new pattern data determined from step 410. The updated rule data may then be analyzed using a further neuro-symbolic AI model to generate one or more recommendations for smart contract rule updates in step 420. For example, the neuro-symbolic AI model may combine the use of symbolic AI along with neural network machine learning to generate decisions and recommendations for defining smart contract rules, similar to the description provided for steps 310 and 315 of FIG. 3. In some examples, the system may generate the neuro-symbolic AI model used to process the dispute as part of step 420. Similar to step 310 (FIG. 3), the system may generate symbolic logic based on historical dispute and transaction information, as well as neural nodes and connections for a machine learning model based on the same data. In some arrangements, the symbolic logic generation may be based on different portions of the historical data than the neural AI machine learning model generation. Additionally or alternatively, the neuro-symbolic AI model may be specific to a transaction feature or feature type, such as a transaction type, customer type, transaction level/amount, geographic location and the like.

In step 425, the system may generate one or more modifications for existing smart contracts or for creation of new contracts based on the analysis in step 420. In one example, the system may generate blockchain commands or code for replacing or updating one or more smart contracts with new or different rules determined from the analysis of step 420. In some examples, the commands may include generating new blockchain nodes representing an update to an existing smart contract. Additionally or alternatively, a new blockchain node representing a new or updated smart contract may be associated with another blockchain node corresponding to an existing prior version of that smart contract. The modifications may then be returned to the overall smart contract orchestration process for implementation into the corresponding blockchain.

In step 430, the system may confirm implementation of one or more modifications to existing smart contracts used for dispute resolution and transaction processing. In one or more examples, the system may require user confirmation for which recommended smart contract updates are to be implemented in the blockchain. Alternatively, the system may automatically implement all recommended smart contract updates.

In step 435, the system may then apply the transaction data to the updated smart contracts in the blockchain in order to determine a resolution to the dispute. In one example, a resolution may include the return of funds if a transaction is disputed as unauthorized. In another example, a resolution may include providing additional funds to an account if the account does not have a necessary amount funds for a transaction. In yet another example, a resolution may be to put a freeze on an account involved in the transaction for a certain amount of time if unauthorized access to that account is detected. The system may generate code that is automatically executed by one or more destination modules, systems, or devices in order to implement the resolutions. For example, that code may cause a system to place a hold on an account, or to transfer funds from one account to another account, or to issue an alert to a customer of possible fraud.

In steps 440 and 445, the system may further train the neuro-symbolic AI model used in steps 410 and 420 based on the implementation of smart contract updates, respectively. For example, the neuro-symbolic AI model of step 410 may be updated to better tailor the model for identifying new patterns or behaviors, and recognizing context. In one particular case, a pattern identified as new may be used to update the neuro-symbolic AI model such that that same pattern is no longer identified as new in subsequent iterations and transactions. In short, the system may learn additional context for identifying patterns within transactions.

Similarly, in step 445, the neuro-symbolic AI model of step 420 may be trained using the decisions resulting from the smart contract updating process to better define the types of rule updates that should or should not be implemented based on the specifics of the transaction data. In one example, if a recommended smart contract update is rejected or otherwise not implemented (e.g., based on a user decision or manual confirmation), that information and decision may be used to further train the rule updating neuro-symbolic model of step 420 to refine how and what recommendations are generated.

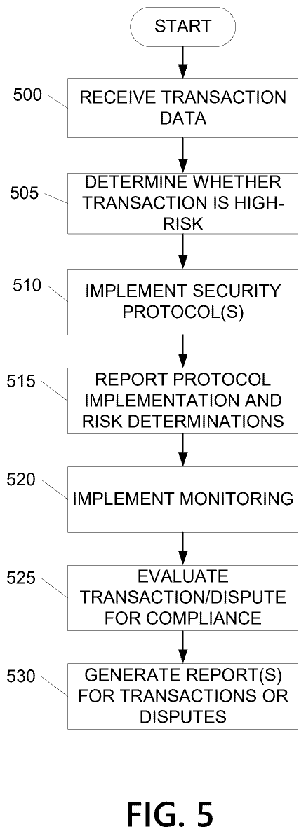

In one or more arrangements, the rule update determination process of step 420 may further include various processes for detecting fraud and monitoring appropriate governance of disputed transactions. FIG. 5 illustrates an example process for such fraud detection and governance monitoring. In step 500, transaction data may be determined or received by the system. In step 505, transactions may be analyzed to determine whether the transaction is a high-risk transaction. A high-risk transaction may be defined using an AI machine-learning model based on a training set of data. A high-risk transaction may refer to a transaction of a certain amount or above, between certain entities, based on historical events associated with one or more of the accounts or entities involved in the transaction, a type of product or service involved in the transaction, the financial institutions, and the like and/or combinations thereof. Additionally or alternatively, the system may determine that a transaction is a high-risk transaction based on one or more transaction parameters being an outlier from a user or entity's prior transaction activity.

In step 510, the system may implement one or more security protocols based on detecting whether the transaction is high-risk. For example, in one or more arrangements, a high-risk determination may require user confirmation before security protocols for high-risk transactions are implemented. Such protocols may include multi-factor authentication, a transaction hold for a certain amount of time, requiring confirmation from a third-party (e.g., another financial institution involved in the transaction, a payor or payee associated with the transaction), and the like and/or combinations thereof. Further, a high-risk determination in addition to any security protocol implementations or implementation recommendations may be returned to the smart contract update process or overall dispute resolution process in step 515.

Further, in step 520, the system may implement a monitoring step in which transactions and disputes are monitored throughout the life of the transaction and/or dispute. Accordingly, when a transaction is initiated or a dispute is detected, the system may initiate a monitoring process for logging or otherwise recording data associated with the transaction and/or dispute. In one or more examples, the types and amount of data logged or recorded may be predefined and/or may vary depending on the type of transaction or dispute. In step 525, while monitoring the transaction or dispute, the system may evaluate the transaction or dispute data to confirm compliance with one or more rules or guidelines. For example, the handling of financial transactions or disputes may be subject to various federal laws, internal rules, guidelines and the like. Accordingly, the system may confirm that the processing of the transaction or dispute adheres to those requirements. These requirements may also be used to enforce security procedures to maintain the privacy and security of the transaction or dispute information. In some cases, the system may identify possible compliance or security issues to an overall transaction handling or dispute resolution process so that they may be addressed before transaction handling or dispute resolution is completed. In one example, such compliance or security issues may be reported to the fraud detection and prevention process of steps 505-515 so that such information may be used in evaluating whether the transaction is a high-risk transaction.

Additionally, in step 530, the system may also generate one or more reports of the recorded data associated with the transaction or dispute. These reports may provide the transaction or dispute information to one or more users, organizations, or other outlets to provide transparency in the handling of the transaction or dispute. Additionally or alternatively, the reports may include compliance and/or security information as determined in step 525, and also may indicate how recently a transaction or dispute resolution process was monitored or evaluated for compliance with one or more guidelines, protocols, and/or requirements.

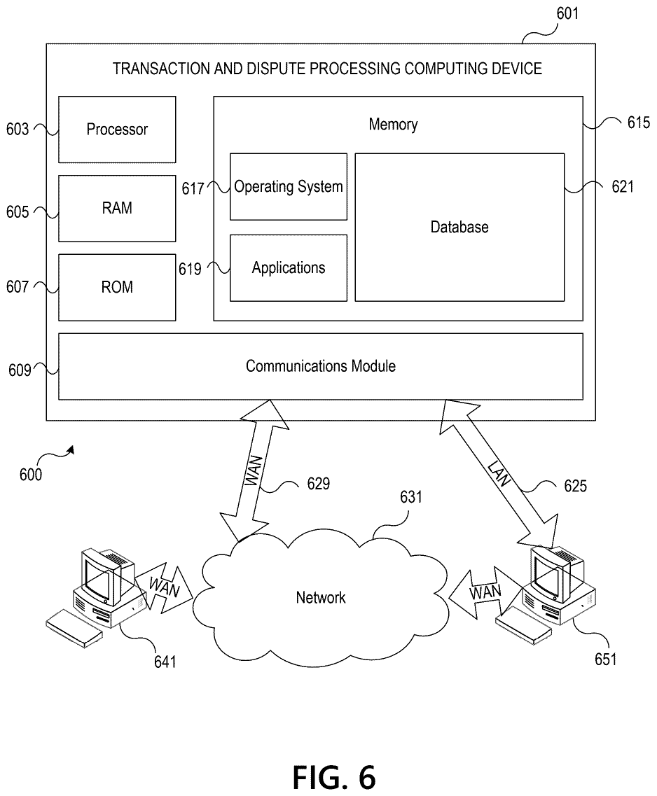

FIG. 6 depicts an illustrative operating environment in which various aspects of the present disclosure may be implemented in accordance with one or more example embodiments. Referring to FIG. 6, computing system environment 600 may be used according to one or more illustrative embodiments. Computing system environment 600 is only one example of a suitable computing environment and is not intended to suggest any limitation as to the scope of use or functionality contained in the disclosure. Computing system environment 600 should not be interpreted as having any dependency or requirement relating to any one or combination of components shown in illustrative computing system environment 600.

Computing system environment 600 may include transaction and dispute processing computing device 601 having processor 603 for controlling overall operation of transaction and dispute processing computing device 601 and its associated components, including Random Access Memory (RAM) 605, Read-Only Memory (ROM) 607, communications module 609, and memory 515. Transaction and dispute processing computing device 601 may include a variety of computer readable media. Computer readable media may be any available media that may be accessed by transaction and dispute processing computing device 601, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by transaction and dispute processing computing device 601.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor on transaction and dispute processing computing device 601. Such a processor may execute computer-executable instructions stored on a computer-readable medium.

Software may be stored within memory 615 and/or storage to provide instructions to processor 603 for enabling transaction and dispute processing computing device 601 to perform various functions as discussed herein. For example, memory 615 may store software used by transaction and dispute processing computing device 601, such as operating system 617, application programs 619, and associated database 621. Also, some or all of the computer executable instructions for transaction and dispute processing computing device 601 may be embodied in hardware or firmware. Although not shown, RAM 605 may include one or more applications representing the application data stored in RAM 605 while transaction and dispute processing computing device 601 is on and corresponding software applications (e.g., software tasks) are running on transaction and dispute processing computing device 601.

Communications module 609 may include a microphone, keypad, touch screen, and/or stylus through which a user of transaction and dispute processing computing device 601 may provide input, and may also include one or more of a speaker for providing audio output and a video display device for providing textual, audiovisual and/or graphical output. Computing system environment 600 may also include optical scanners (not shown).

Transaction and dispute processing computing device 601 may operate in a networked environment supporting connections to one or more other computing devices, such as computing device 641 and 651. Computing devices 641 and 651 may be personal computing devices or servers that include any or all of the elements described above relative to transaction and dispute processing computing device 601.

The network connections depicted in FIG. 6 may include Local Area Network (LAN) 625 and Wide Area Network (WAN) 629, as well as other networks. When used in a LAN networking environment, transaction and dispute processing computing device 601 may be connected to LAN 625 through a network interface or adapter in communications module 609. When used in a WAN networking environment, transaction and dispute processing computing device 601 may include a modem in communications module 609 or other means for establishing communications over WAN 629, such as network 631 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like that are configured to perform the functions described herein.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

1. A method comprising:
detecting, by a dispute resolution processing computing system, a dispute associated with a transaction of a first entity;
determining one or more transaction parameters for the transaction subject to the dispute, the transaction parameters including a device type or model through which a transaction request, corresponding to the transaction of the first entity, was made, a geographic location from which the transaction request was received, and a unique identifier of the first entity;
blocking transactions for one or more accounts of the first entity;
determining, using a first neuro-symbolic artificial intelligence model, that the transaction is complex, wherein determining that the transaction is complex includes analyzing, using the first neuro-symbolic artificial intelligence model, the transaction and historical transactions of the first entity to determine that the transaction establishes a pattern of transaction behavior that is new to the first entity;
in response to determining that the transaction is complex:
generating one or more modifications to one or more existing smart contracts in a blockchain network using a second neuro-symbolic artificial intelligence model different from the first neuro-symbolic artificial intelligence model, wherein the one or more smart contracts are configured to generate dispute resolutions, the second neuro-symbolic artificial intelligence model being specific to a transaction type of the transaction of the first entity;
updating the one or more smart contracts based on the generated one or more modifications; and
after updating the one or more existing smart contracts, determining a resolution to the dispute using the updated one or more smart contracts.

2. The method of claim 1, wherein determining, using the first neuro-symbolic artificial intelligence model, that the transaction is complex, includes:
obtaining transaction data for the historical transactions;
analyzing the transaction data along with the one or more transaction parameters for the transaction subject to the dispute to identify one or more transaction patterns; and
determining that at least one of the one or more transaction patterns are new.

3. The method of claim 1, wherein updating the one or more smart contracts includes:
generating a new node in the blockchain with a new smart contract having one or more updated rules.

4. The method of claim 3, further comprising:
associating the new node with an existing node in the blockchain, the existing node in the blockchain storing a prior version of the new smart contract.

5. (canceled)

6. The method of claim 1, further comprising generating the first neuro-symbolic artificial intelligence model, including:
obtaining transaction data for one or more historical transactions;
extracting transaction features from the transaction data;
defining a plurality of symbolic rules using at least one of the plurality of transaction features; and
generating a plurality of machine learning nodes and connections, wherein each of the nodes represents one of the transaction features and each of the connections represents a relationship between at least two of the nodes.

7. The method of claim 1, further comprising selecting the second neuro-symbolic artificial intelligence model based on the transaction type.

8. An apparatus comprising:
a processor; and
memory storing computer-readable instructions that, when executed, cause the apparatus to:
detect a dispute associated with a transaction of a first entity;
determine one or more transaction parameters for the transaction subject to the dispute, the transaction parameters including a device type or model through which a transaction request, corresponding to the transaction associated with the dispute, was made, a geographic location from which the transaction request was received, and a unique identifier of the first entity;
block transactions for one or more accounts of the first entity;
determine, using a first neuro-symbolic artificial intelligence model, whether the transaction is complex, wherein determining whether the transaction is complex includes analyzing, using the first neuro-symbolic artificial intelligence model and historical transactions of the first entity, whether the transaction establishes a pattern of transaction behavior that is new to the first entity;
in response to determining that the transaction is complex ;:
generate one or more modifications to one or more existing smart contracts in a blockchain network using a second neuro-symbolic artificial intelligence model different from the first neuro-symbolic artificial intelligence model, wherein the one or more smart contracts are configured to generate dispute resolutions, the second neuro-symbolic artificial intelligence model being specific to a transaction type of the transaction of the first entity;
update the one or more smart contracts based on the generated one or more modifications; and
after updating the one or more existing smart contracts, determine a resolution to the dispute using the updated one or more smart contracts.

9. The apparatus of claim 8, wherein determining, using the first neuro-symbolic artificial intelligence model, whether the transaction is complex, includes:
obtaining transaction data for the historical transactions;
analyzing the transaction data along with the one or more transaction parameters for the transaction subject to the dispute to identify one or more transaction patterns; and
determining whether any of the identified one or more transaction patterns are new.

10. The apparatus of claim 8, wherein updating the one or more smart contracts includes:
generating a new node in the blockchain with a new smart contract having one or more updated rules.

11. The apparatus of claim 10, wherein the instructions, when executed, further cause the apparatus to:
associate the new node with an existing node in the blockchain, the existing node in the blockchain storing a prior version of the new smart contract.

12. The apparatus of claim 8, wherein the instructions, when executed, further cause the apparatus to:
in response to determining that the transaction is not complex, determining the resolution to the dispute using the one or more existing smart contracts.

13. The apparatus of claim 8, wherein the instructions, when executed, further cause the apparatus to generate the first neuro-symbolic artificial intelligence model, including:
obtaining transaction data for the historical transactions;
extracting transaction features from the transaction data;
defining a plurality of symbolic rules using at least one of the plurality of transaction features; and
generating a plurality of machine learning nodes and connections, wherein each of the nodes represents one of the transaction features and each of the connections represents a relationship between at least two of the nodes.

14. The apparatus of claim 8, wherein the instructions, when executed, further cause the apparatus to select the second neuro-symbolic artificial intelligence model based on the transaction type.

15. A non-transitory computer-readable medium storing computer readable instructions that, when executed, cause an apparatus to:
detect a dispute associated with a transaction of a first entity;
determine one or more transaction parameters for the transaction subject to the dispute, the transaction parameters including a device type or model through which a transaction request, corresponding to the transaction associated with the dispute, was made, a geographic location from which the transaction request was received, and a unique identifier of the first entity;
block transactions for one or more accounts of the first entity;
determine, using a first neuro-symbolic artificial intelligence model, whether the transaction is complex,
wherein determining whether the transaction is complex includes analyzing, using the first neuro-symbolic artificial intelligence model and historical transactions of the first entity, whether the transaction establishes a pattern of transaction behavior that is new to the first entity;
in response to determining that the transaction is complex:
generate one or more modifications to one or more existing smart contracts in a blockchain network using a second neuro-symbolic artificial intelligence model different from the first neuro-symbolic artificial intelligence model, wherein the one or more smart contracts are configured to generate dispute resolutions, the second neuro-symbolic artificial intelligence model being specific to a transaction type of the transaction of the first entity;
update the one or more smart contracts based on the generated one or more modifications; and
after updating the one or more existing smart contracts, determine a resolution to the dispute using the updated one or more smart contracts.

16. The non-transitory computer-readable medium of claim 15, wherein determining, using the first neuro-symbolic artificial intelligence model, whether the transaction is complex, includes:
obtaining transaction data for the historical transactions;
analyzing the transaction data along with the one or more transaction parameters for the transaction subject to the dispute to identify one or more transaction patterns; and
determining whether any of the identified one or more transaction patterns are new.

17. The non-transitory computer-readable medium of claim 15, wherein updating the one or more smart contracts includes:
generating a new node in the blockchain with a new smart contract having one or more updated rules.

18. The non-transitory computer-readable medium of claim 17, wherein the instructions, when executed, further cause the apparatus to:
associate the new node with an existing node in the blockchain, the existing node in the blockchain storing a prior version of the new smart contract.

19. The non-transitory computer-readable medium of claim 15, wherein the instructions, when executed, further cause the apparatus to:
in response to determining that the transaction is not complex, determining the resolution to the dispute using the one or more existing smart contracts.

20. The non-transitory computer-readable medium of claim 15, wherein the instructions, when executed, further cause the apparatus to generate the first neuro-symbolic artificial intelligence model, including:
obtaining transaction data for the historical transactions;
extracting transaction features from the transaction data;
defining a plurality of symbolic rules using at least one of the plurality of transaction features; and
generating a plurality of machine learning nodes and connections, wherein each of the nodes represents one of the transaction features and each of the connections represents a relationship between at least two of the nodes.
